(19) United States
(12) Patent Application Publication
(10) Pub. No.: US 2012/0137910 A9
(43) Pub. Date: Jun. 7, 2012

(54) Printed Security Features

(76) Inventors: Simon Dexter Marchant, Hampshire (GB); Paul Howland, Hampshire (GB)

(21) Appl. No.: 13/124,489

(22) PCT Filed: Sep. 29, 2009
(86) PCT No.: PCT/GB2009/002327

§ 371 Date: Jun. 17, 2011

(30) Foreign Application Priority Data
Oct. 16, 2008 (GB) 0819005.0

(51) Int. Cl. B41F 33/00; B42D 15/10; B42D 15/00

(52) U.S. Cl. 101/483; 283/85; 283/81; 283/75

(57) ABSTRACT

The invention relates to improvements in security features which comprise at least one printed image and, in particular, to such security features which provide an improvement in the resolution of printed images forming security features using inks, pigments or printing processes which do not lend themselves to the production of sharply defined or high resolution images. The security feature comprises an opaque first image and a second image at least partially overlying the first image, the second image being a printed image which has a lower visual resolution than the first image. The formation of the second image is such that, when the security feature is viewed in transmitted and/or reflected light, only the shape of the first image is readily discernable.

### CROSS-REFERENCE TO RELATED APPLICATIONS

This application is the United States National Phase of PCT Patent Application No. GB2009/002327 filed on 29 Sep. 2009, which was published in English on 22 Apr. 2010 under Publication No. W02010/043846 A1, which claims priority to Great Britain Patent Application No. 0819005.0 filed 16 Oct. 2008, both of which are incorporated herein by reference.

The invention relates to improvements in security features which comprise at least one printed image and, in particular, to such security features which provide an improvement in the resolution of printed images forming security features using inks, pigments or printing processes which do not lend themselves to the production of sharply defined or high resolution images.

Printed security features on security documents often require, or benefit from, high resolution print. For example micro print, which is often used on security documents, is challenging for counterfeiters to replicate, but is only possible if the print is of sufficient resolution. In cases where the print is on a transparent or translucent substrate images may be viewed in transmission and may interact with images on the opposite side of the document, for example to produce moiré interference patterns. In such cases high resolution images produce better effects than low resolution images. Poor image resolution images, on the other hand, are easier to counterfeit and detract from the aesthetic appeal of the document.

Conversely it is desirable in some circumstances to use inks, pigments or printing processes that do not lend themselves to the production of sharply defined or high resolution images. There are a number of reasons why print resolution may be compromised:
If the ink pigment has a large particle size the resolution will be limited by the particle diameter.
Examples of this are optically variable pigments which have to have a diameter of at least 10 μm, and more preferably at least 20 microns, and even more preferably at least 30 microns, in order to achieve a good optically variable effect.
If the ink pigment particles have a low packing density the space between the particles will limit the resolution of the image. An example of this would be particles that are very expensive and it is thus desirable to use them sparingly to keep costs down. Alternatively it may be desirable to have an image that is translucent and this may only be achievable by using low pigment densities.
If the printing process has inherent resolution limitations. Examples of this are gravure printing, with large cells to accommodate large particles such as optically variable pigments, and screen printing, where a very coarse screen is used to apply a thick layer of ink to produce a tactile image.

In some cases all, or several, of these reasons may apply to a printed image. The problem which is faced by security printers is how to produce a high resolution image in combination with a printing process or ink that is inherently capable of only producing a low resolution image.

According to the invention there is therefore provided a security feature comprising an opaque first image and a second image at least partially overlying the first image, the second image being a printed image which has a lower visual resolution than the first image and the formation of the second image is such that, when the security feature is viewed in transmitted and/or reflected light, only the shape of the first image is readily discernable.

The invention also provides a security device comprising a substantially transparent carrier substrate on which is formed the aforementioned security feature, a security substrate comprising a substrate and said security device and a security document formed from said substrate.

The invention further provides a method of forming the aforementioned security feature comprising the steps forming on a substrate a first opaque image and a printed second image at least partially overlying the first image, the second image being a printed image which has a lower visual resolution than the first image and the formation of the second image is such that, when the security feature is viewed in transmitted and/or reflected light, only the shape of the first image is readily discernible.

Preferred embodiments of the present invention will now be described, by way of example only, with reference to the accompanying drawings, in which:

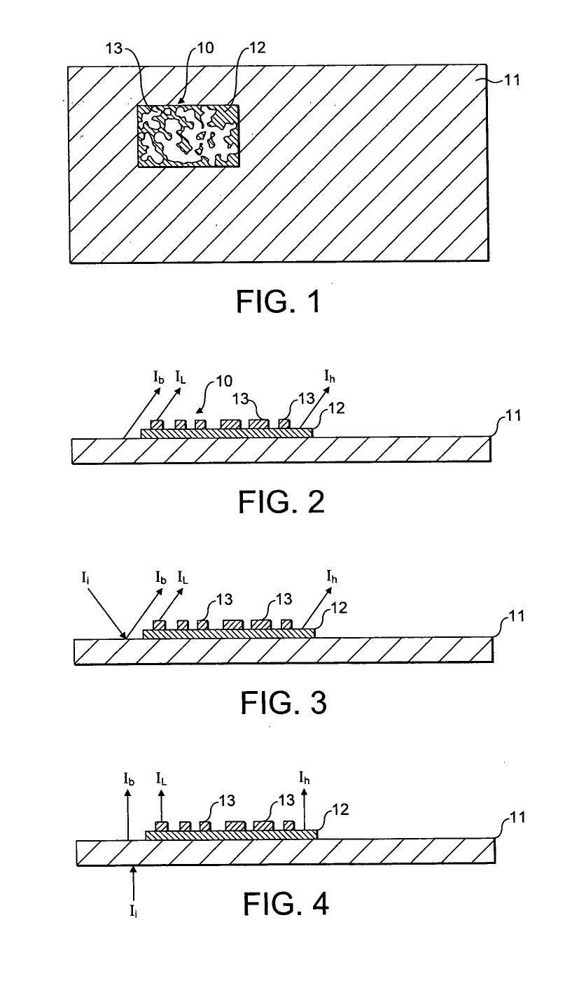

FIG. 1 is plan view of a security document bearing a printed security feature according to the present invention;

FIG. 2 is a cross sectional side elevation of the security document of FIG. 1 on the line II-II;

FIG. 3 is the same cross sectional side elevation of the security document of FIG. 2 showing the reflection viewing mode;

FIG. 4 is the same cross sectional side elevation of the security document of FIG. 2 showing the transmission viewing mode;

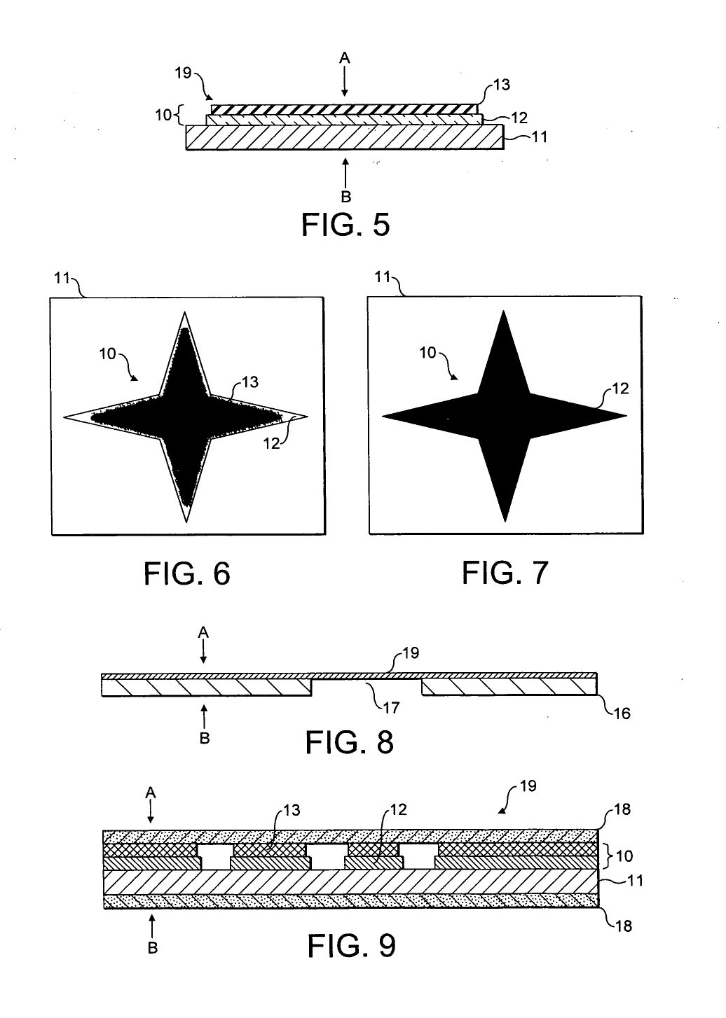

FIG. 5 is a cross sectional side elevation of a security document bearing an alternative printed security feature according to the present invention;

FIG. 6 is a plan view of the security document Of FIG. 5 viewed in reflective light;

FIG. 7 is a plan view of the security document Of FIG. 5 viewed in transmitted light;

FIG. 8 is a cross sectional side elevation of a security device applied to a substrate;

FIG. 9 is a security device having a security feature according to the present invention applied to a carrier film in preparation for application to a carrier substrate;

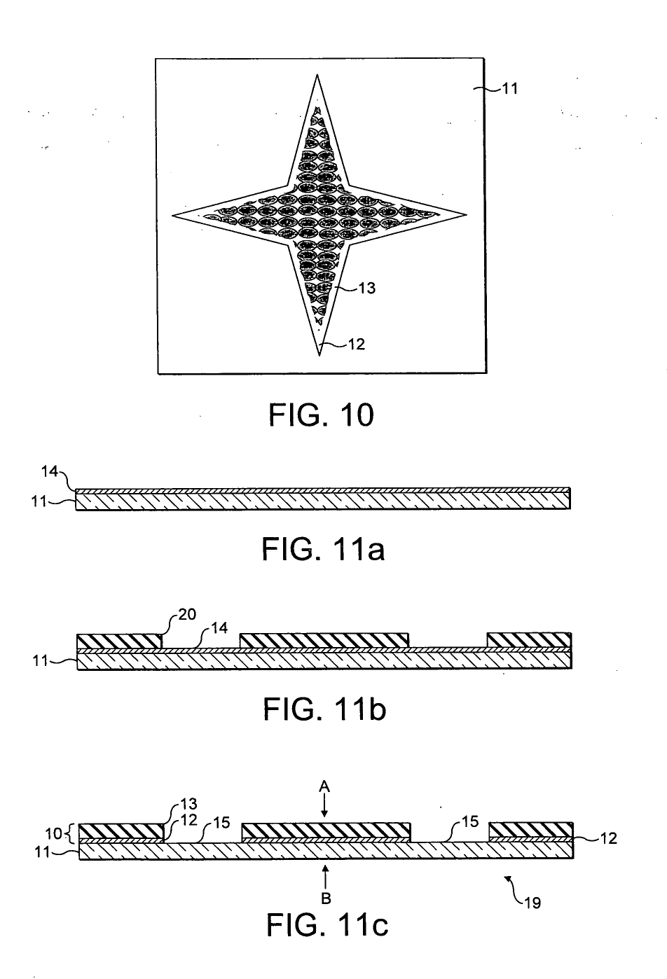

FIG. 10 is a view similar to that of FIG. 6 showing the use of optically variable pigments;

FIGS. 11a to 11c are cross sectional side elevations showing the steps of one method of forming the security feature of the present invention;

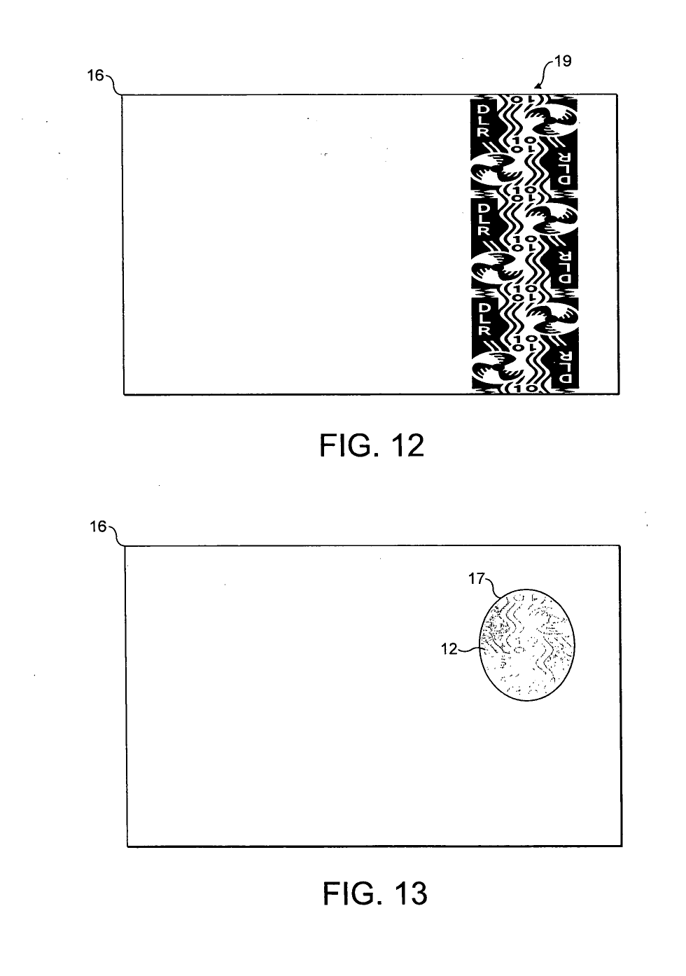

FIG. 12 is a plan view of one side of a security substrate incorporating a security device bearing a security feature according to the present invention;

FIG. 13 is a view of the opposite side of the security substrate of FIG. 12;

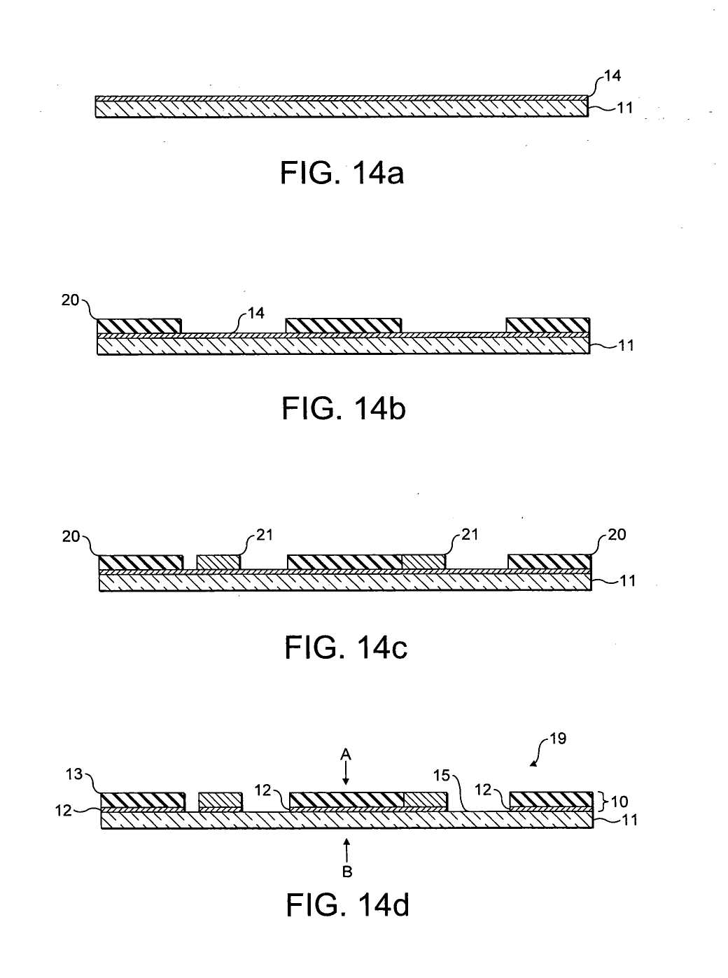

FIGS. 14a to 14d illustrate the steps involved in another method of forming the security feature of the present invention;

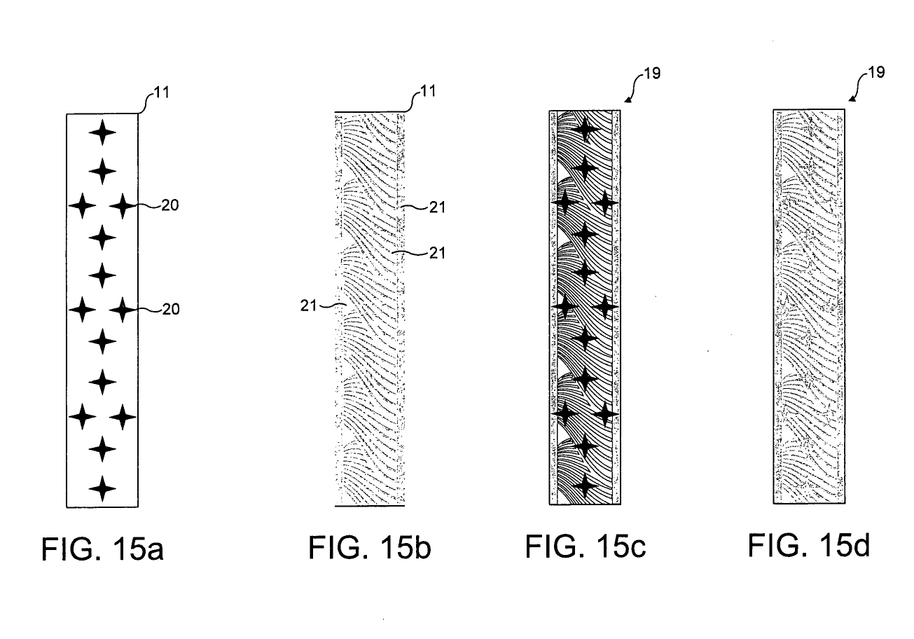

FIGS. 15a to 15d are plan views of the different stages in the formation of a security feature on a security device by the method illustrated in FIGS. 14a to 14d;

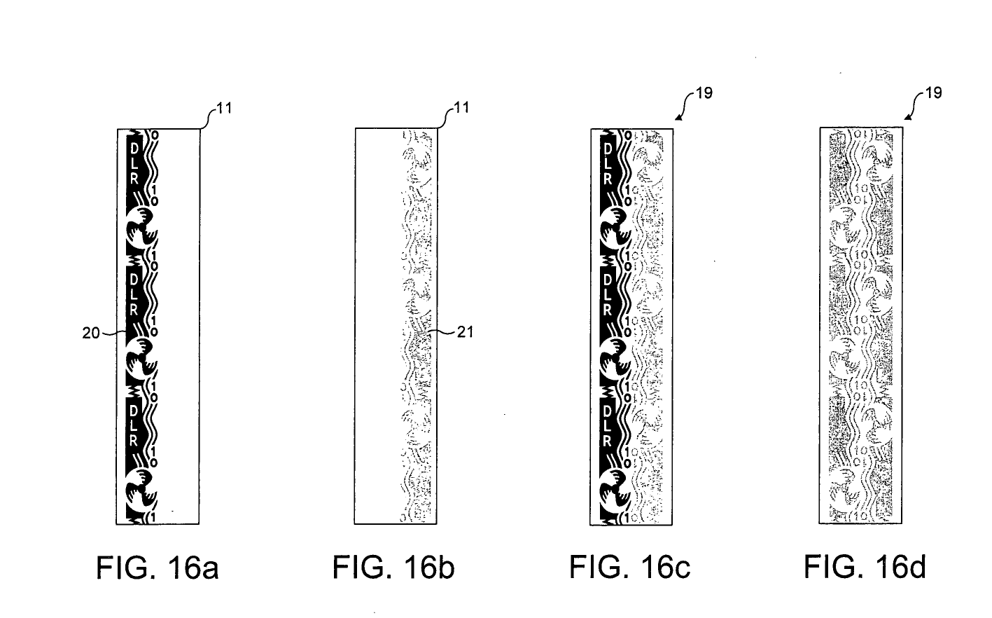

FIGS. 16a to 16d are plan views of the different stages of formation of an alternative embodiment of a security feature of the present invention on a security device;

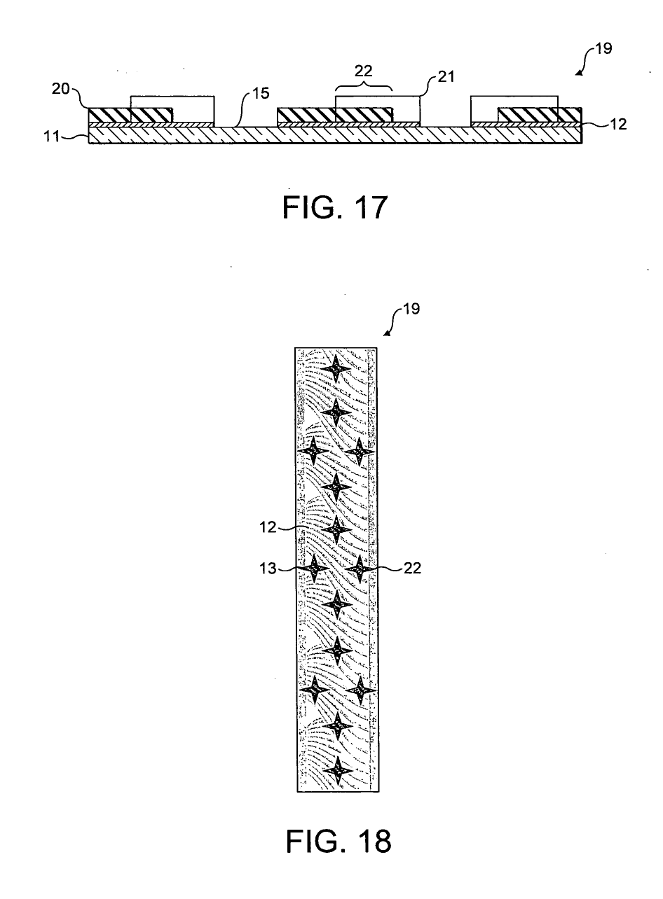

FIG. 17 is a cross sectional side elevation of a security device having a security feature according to the present invention;

FIG. 18 is a plan view of the security device of FIG. 17;

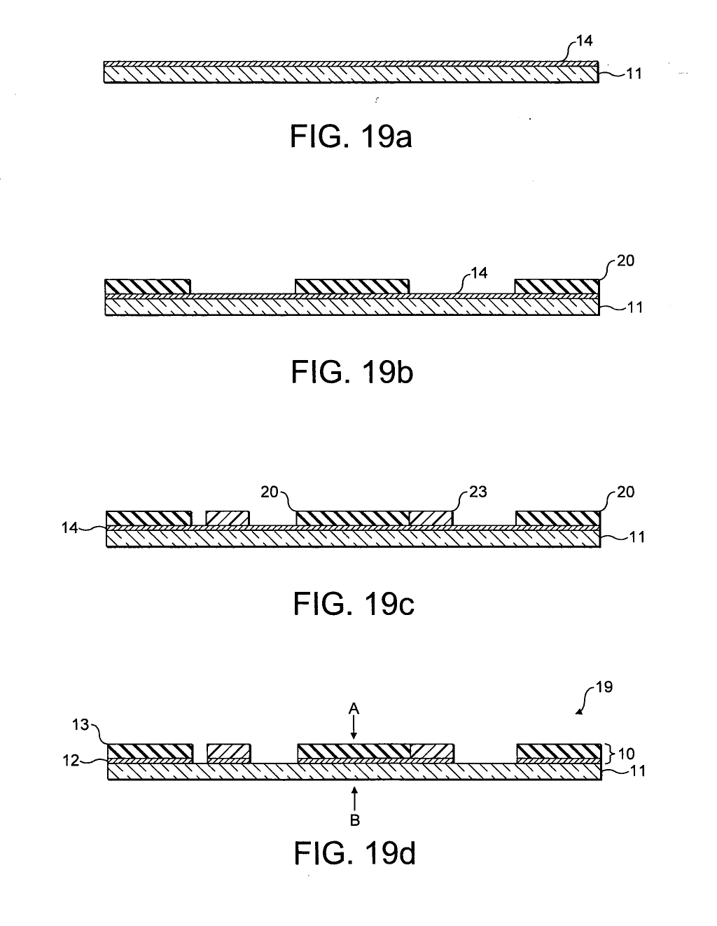

FIGS. 19a to 19d illustrate the steps involved in another method of forming the security feature of the present invention;

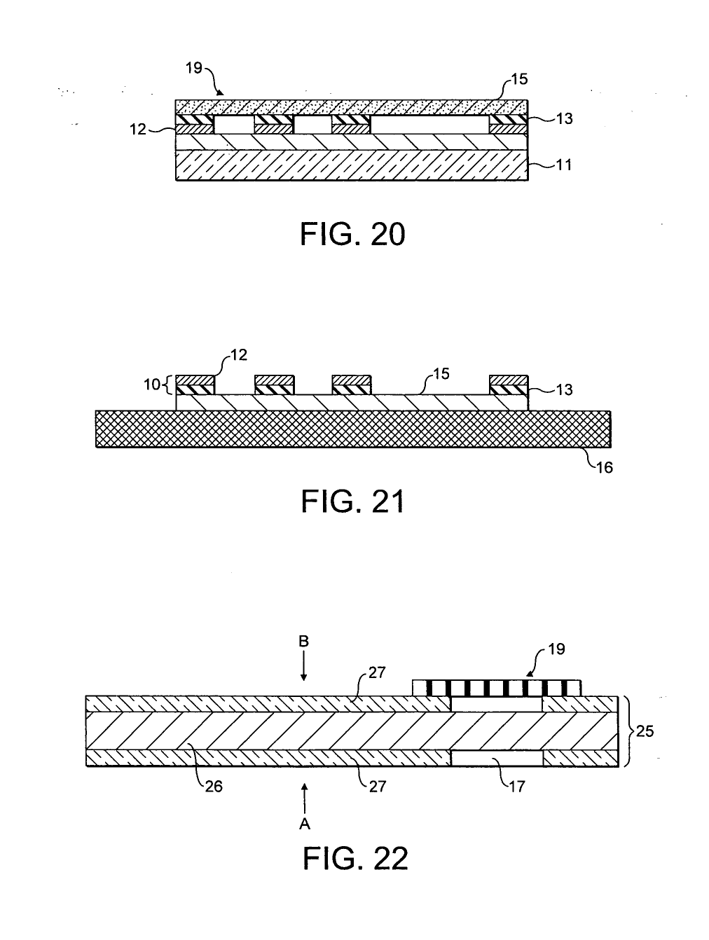

FIG. 20 is a cross sectional side elevation of a security device having a security feature according to the present invention suitable for application as a stripe or patch;

FIG. 21 is a cross sectional side elevation of the security device of FIG. 20 applied to a security document; and

FIG. 22 is a cross sectional side elevation of the security device of FIG. 20 applied over a transparent region of a security document.

In its very broadest sense the present invention is a security feature which comprises a high resolution first image on a substrate, over which is a printed second image that has a low resolution and which preferably has an optical, tactile or other effect. The images are overlaid and, when viewed in transmitted and/or reflected light only the shape of the high resolution image is readily discernable, but not the shape of the low resolution image. This can be due either to the relative positioning and shape of the two images, such that the second image does not extend beyond the boundaries of the first image and/or to the composition of the ink from which the second image is formed. The optical properties of the two images can be adjusted so as to give a low contrast ratio in at least one viewing mode, namely transmission or reflection. Thus any advantageous optical, tactile or other properties of the low resolution image do not compromise the resolution of the overall image perceived by the viewer.

The security features of the present invention can be applied to a variety of substrates, some of which are as follows:

a) elongate security elements and tapes used in the production of security substrates. There are many examples of these known in the prior art, including those described in EP-A-0059056, EP-A-086029, EP-A-1141480 and WO-A-03054297;
b) polymer security substrates, especially those comprising an uncoated windowed region;
c) foils applied as strips or patches or the like to paper or polymer security substrates;
d) images printed directly onto paper and polymer security substrates or documents.

Preferably the optical properties of the two images forming the security feature conform to certain rules. In particular the contrast ratio of the two images viewed in either reflection or transmission should be small.

FIG. 1 illustrates a security feature 10 of the present invention formed on a substrate 11, such as a paper security document. A high resolution image 12 is applied to the substrate 11 first and a low resolution image 13 is applied to the high resolution image 12.

Referring to FIG. 2, the reflected light intensity (I) is defined as the light energy flux incident to or transmitted from a surface. The contrast ratio (R_{b}) of the overall image relative to the background is:—

R_{b}=((Iₕ+I_{L})/2)/I_{b}

The contrast ratio (Rₕ) of the low resolution image 13 relative to the high resolution image 12 is:—

Rₕ=I_{L}/Iₕ

where:—
Iₕ is the light intensity of the light reflected from the high resolution image 12 I_{L} is the light intensity of the light reflected from the low resolution image 13 I_{b} is the light intensity of the light reflected from the background. Iᵢ is the light intensity of the incident light

It is preferred that Rₕ<<R_{b} in either the reflection viewing mode or the transmission viewing mode or both modes of viewing. It is also preferred that Rₕ/R_{b}<0.2. The different viewing modes are shown in FIGS. 3 and 4, with FIG. 3 showing the reflection mode and FIG. 4 showing the transmission mode.

Preferably the majority of the perimeter of the low resolution image 13 lies within the perimeter of the high resolution image 14, and more preferably more than 80% of the length of the perimeter of the low resolution image 13 lies within the perimeter of the high resolution image 12.

The images 12,13 of the security feature 10 can be formed in a number of different ways. Some of these are as follows:

### a) Print Processes

Print processes represent simple registered printing in which the low resolution image 13 is printed over and in register with the high resolution image 12. The print can be applied to an opaque, translucent or transparent substrate 11. In the case of a transparent substrate 11, particular effects can be obtained when the optical properties of the two images 12,13 are different in either transmission or reflection mode. Examples of this will be given below when discussing further specific embodiments of the invention.

### b) Resist and Etch Process

In this method an ink, comprising one or more optically variable pigments, is used as a resist in the so called “resist and etch” method of producing demetallised images. It has been found that the ink, which is printed using screen or gravure printing methods, produces a rather low resolution image 13 because of the large pigment particle size and/or because the particles are used in a low density. The ink is printed onto the surface of a metallised film, which is then demetallised by immersing it in sodium hydroxide before being washed in water. The resultant security feature 10 comprises a poorly defined printed optically variable image 13 under which is a well defined metal image 12.

Optically variable pigments suitable for use in the present invention include cholesteric liquid crystal pigments, pearlescent pigments and thin film interference pigments and holographic flakes. When these optically variable pigments are used in inks, the resolution of the image 13 is limited both in terms of the line widths achievable and the sharpness of the image outline, i.e. the edge definition of the image 13. This is due to the fact that the optically variable pigments, are much larger than conventional pigments so that it is not possible to produce sharply defined indicia by directly printing the inks containing such pigments. Optically variable pigments have to have a diameter of at least 10 μm, and more preferably at least 20 microns, and even more preferably at least 30 microns, in order to achieve a good optically variable effect.

The combination of the non-optically variable (high resolution) image 12 superimposed by the optically variable (low resolution) image 13 allows the security feature 10 to have a sharp outline, provided that the optically variable pigments do not extend beyond the periphery of the non-optically variable image 12. In this case the sharp outline of the security feature 10 is provided by the substantially opaque material of the non-optically variable image 12. This allows a sharp silhouette of the security feature 10 to be viewed in transmitted light, which would not be possible if the coating containing the coarse optically variable pigment used to form the low resolution image 13 is printed directly onto a transparent substrate 11.

FIGS. 5 to 7 illustrate how the security features of the present invention solve the problem of poor edge definition. The security feature 10 is preferably formed on a transparent substrate 11, by applying thereto a patterned opaque layer to form the high resolution image 12, for example of vapour-deposited aluminium. An optically variable ink, comprising a coarse pigment, is then printed in register over the high resolution image 12 to provide the low resolution image 13, such that image 13 follows the same edge outline of the image 12. The pigments present in the ink do not extend beyond the edge of the first image 12.

When the security feature 10 is viewed in reflected light from the direction of arrow A, it is observed to have the optically variable effect of the optically variable effect ink. Although the optically variable effect ink has a poor edge definition, as shown in FIG. 6, this is not readily apparent due to the presence of the high resolution image 12 which effectively provides a solid frame around the optically variable image 13. On viewing from the direction of arrow B in reflected light the security feature 10 will appear non-optically variable and, in this example, will have a metallic appearance. On viewing the security feature 10 in transmitted light from either direction A,B (FIG. 7) a sharp dark silhouette of the image 12 will be viewed with a high edge definition.

The security feature 10 may be formed in a manner that enables it to be viewed in a substantially transparent region of an otherwise opaque security substrate 16, such as a paper or polymer substrate or a document made therefrom. In order to achieve this, the security feature 10 may be applied to a substrate 11, which is a substantially transparent polymeric carrier film, to form a security device 19. The high resolution image 12 is formed by a layer of a substantially opaque non-optically variable material, such as a vacuum deposited metallic layer. The low resolution image 13 is formed by printing a layer of an optically variable material, such as resinous coating comprising one or more optically variable pigments.

The security device 19 may subsequently be incorporated into the security substrate 16 such that it is viewable from both sides of the substrate 16. Methods of incorporating security devices 19 in such a manner are described in EP-A-1141480 and WO-A-03054297. In the method described in EP-A-1141480, one side of the security device is wholly exposed at one surface of the substrate in which it is partially embedded, and partially exposed in windows at the other surface of the substrate.

Security substrates may be formed from any conventional materials, including paper and polymer. Techniques are known in the art for forming substantially transparent regions in each of these types of substrate. For example, WO-A-8300659 describes a polymer banknote formed from a transparent substrate comprising an opacifying coating on both sides of the substrate. The opacifying coating is omitted in localised regions on both sides of the substrate to form a transparent region. WO-A-0039391 describes a method of making a transparent region in a paper substrate. Other methods for forming transparent regions in paper substrates are described in EP-A-723501, EP-A-724519, WO-A-03054297 and EP-A-1398174.

Another method of incorporating a security device in a security substrate, such that it is viewable from both sides of the substrate, is described in EP-A-1141480. In this method, as illustrated in FIG. 8, the security device 19 is in the form of a wide elongate element and is selectively exposed on one side of the security substrate and fully exposed on the other side to produce a transparent area 17. This method enables the insertion of considerably wider security elements into security substrates than other methods allow.

FIG. 9 shows a cross-sectional view of a security device 19 bearing a security feature 10 according to the present invention that is suitable for incorporation in a security substrate 16 in the manner described in EP-A-1141480. The security feature 10 is formed on a substrate 11, which is a substantially transparent polymeric carrier film. The high resolution image 12 in formed on the substrate as metallised indicia.

It is well known how to produce partially metallised/demetallised films in which no metal is present in controlled and clearly defined areas. One way is to selectively demetallise regions using a resist and etch technique such as is described in U.S. Pat. No. 4,652,015. Other techniques are known for achieving similar effects; for example aluminium can be vacuum deposited through a mask, or aluminium can be selectively removed from a composite strip of a plastic carrier and aluminium using an excimer laser.

The low resolution image 13 is then applied by printing an optically variable ink or coating to, and in register with, the metallic high resolution image 12 such that the two images 12,13 have the same shape and follow the same edge profile. Preferably the low resolution image 13 does not extend beyond the high resolution image 12. More preferably the low resolution image 13 is indented relative to the high resolution image 12 by at least 10 microns, but preferably no greater than 100 microns. An adhesive coating 18 may be applied to both sides 14,15 of the device 19 to improve its adherence with the security substrate 16 when embedded therein.

In a modification of the above-mentioned method the resist used in the resist and etch method comprises optically variable pigments and is used to form the low resolution second image 13. The use of an optically variable resist ensures exact register between the low resolution image 13 formed therefrom and the high resolution image 12 formed by the remaining metal. Furthermore it has been observed that, when such a resist is applied to metal, the optically variable pigments in the resist tend to recede away from the edge of the resist coating thus ensuring that the optically variable pigments do not extend beyond the edge of the metal forming the high resolution second image 12 as shown in FIG. 10. It is to be noted, however, that this is a schematic figure and the pigments would not be arranged in such a uniform manner.

Referring to FIGS. 11a to 11c, a further alternative method utilises a metallised film comprising a substantially clear polymeric film of BOPP or the like, which forms the substrate 11, which has an opaque layer of metal 14 on a first side thereof (FIG. 11a). A resist 20 which contains an optically variable pigment is printed onto metal layer 14 to form the low resolution image 13 (FIG. 11b). An example of a class of suitable resist materials is vinyl chlorides/vinyl acetate copolymers such as Union Carbide Ucar resins, Sun VHL 31534, or Wacker Vinnol E 15/45m. The printed metallised film is then partially demetallised, according to a known demetallisation process using a caustic wash, which removes the metal in the regions 15 not printed with the resist 20. The remaining regions of metal (i.e. those coated with resist 20) form the high resolution image 12 and combination of the images 12,13 create optically variable indicia which are visible when the security device 19 is viewed under reflected light from the direction of arrow A. The indicia are also viewable under reflected light from the direction of arrow B, but in this case they will appear metallic and not optically variable.

The images 12,13 and/or indicia created by the images 12,13 preferably take the form of words, numerals, patterns and the like. The optically variable resist 20 can be printed such that the indicia are formed from regions of the resist 20 thus creating positive indicia. Alternatively the optically variable resist 20 may be printed so as to form indicia negatively, in which case the resulting indicia will be provided by the demetallised regions 15. The indicia, however formed, are clearly visible from both sides in both reflected light and transmitted light due to the contrast between the demetallised 15 regions and the remaining opaque regions which form the high resolution image 12.

The security device 19 is preferably incorporated into a security substrate 16, using the method described in EP-A-1141480, such that the low resolution image 13 is fully exposed on the front of the substrate 16 and the high resolution image 12 is exposed in a transparent window 17 on the back of the substrate 16. When the front of the substrate 16 is viewed, (as shown in FIG. 12), optically variable indicia are observed which change colour on angle of view for example switching from red to green as the substrate 16 is tilted away from normal incidence. When the back of the security substrate 16 is viewed in reflected light, as shown in FIG. 13, in the area 17 where it is exposed on both sides, the indicia appear metallic. If the security substrate 16 is viewed in transmitted light, a sharp silhouette of the indicia is observed due to the high edge definition of the metallic high resolution image 12 and the fact that the optically variable pigments in the low resolution image 13 do not extend beyond the edge of the metal. The device 19 could also be reversed so that the optically variable indicia are visible in the transparent window 17 when viewed from the back and the metallic indicia visible when viewed from the front.

The device shown in FIG. 9 could also be incorporated into a security substrate 16 as a “windowed thread” as described in EP-A-0059056. EP-A-0059056 describes a method of manufacture of windowed thread paper on a cylinder mould paper-making machine. The technique involves embossing the cylinder mould cover to form raised regions and bringing an impermeable elongate security element into contact with the raised regions of the mould cover, prior to the contact entry point into a vat of aqueous paper stock. Where the impermeable security element makes intimate contact with the raised regions of the embossing, no fibre deposition can occur and windows are formed in the surface of the paper. After the paper is fully formed and couched from the cylinder mould cover, water is extracted from the wet fibre mat and the paper is passed through a drying process. In the finished paper the regions of the security element which are exposed in the windows are visible in reflected light on one side of the paper. This feature is commonly used for banknotes.

In a windowed thread configuration, the optically variable indicia will be visible in reflected light on one side of the substrate 16 where the windows expose the security device 19. When viewed in transmitted light, a sharp silhouette of the indicia will be observed due to the presence of the underlying metal high resolution image 12 being in register with the OVI low resolution image 13. As the security device 19 is only exposed on one side of the substrate 16 the non-optically variable metallic indicia will not be visible in reflected light.

Optically variable pigments having a colour shift between two distinct colours, with the colour shift being dependent on the viewing angle, are well known. The production of these pigments, their use and their characteristic features, are described in U.S. Pat. No. 4,434,010, U.S. Pat. No. 5,059,245, U.S. Pat. No. 5,084,351, U.S. Pat. No. 5,135,812, U.S. Pat. No. 5,171,363, U.S. Pat. No. 5,571,624, EP-A-0341002, EP-A-0736073, EP-A-668329, EP-A-0741170 and EP-A-1114102. Optically variable pigments having a viewing angle dependent shift of colour are based on a stack of superposed thin-film layers with different optical characteristics. The hue, the amount of colour-shifting and the chromaticity of such thin-film structures depend inter alia on the material constituting the layers, the sequence and the number of layers, the layer thickness, as well as on the production process. Generally, optically variable pigments comprise an opaque totally reflecting layer, a dielectric layer of a low refractive index material (i.e. with an index of refraction of 1.65 or less) deposited on top of the opaque layer and a semi-transparent partially reflecting layer applied on the dielectric layer.

Alternative optically variable pigments to the multilayer thin film structures discussed above are pearlescent pigments. Pearlescent pigments have a lamellar substrate of low refractive index such as mica, PET or synthetic mica coated with a metal oxide of high refractive index, for example silicon oxide, titanium oxide or iron oxide. Such a structure results in the appearance of iridescent colours due to interference occurring through mutual interference of the incident light and reflected light at the surface of the metal oxide coating layers coated on their surfaces and the lamellar substrate surface and at the coating interface with the metal oxide. Consequently, if materials having a high refractive index, transparency, and smooth and uniform optical properties are used as the coating layer, pigments of high lustre, with highly iridescent colours due to interference are obtained.

Pearlescent inks can be obtained from Merck under the trade name Iriodin®.

A further alternative optically variable pigment is a liquid crystal pigment. Optically variable liquid crystal pigments are formed from a liquid crystal polymer which has been cross-linked such that its molecules are fixed in the cholesteric phase. Once the film is made, it can be fractured to small platelets. These platelets retain all the optical properties of cholesteric liquid crystal film and therefore exhibit an optically variable angular dependent colour variation. Optically variable liquid crystal pigments can be obtained from Sicpa under the tradename Oasis®.

Experimental evidence has shown that a pigment level by weight of at least 10% and more preferably at least 20% is required to achieve a full coverage of the optically variable pigment across the surface of the indicia.

In an adaptation of the foregoing method a second clear resist 21 is printed on to the vapour deposited aluminium layer, as illustrated in FIGS. 14a to 14d. The clear resist 21 and the optically variable resist 20 can be printed in register or out of register. When the resulting security device 19 is viewed under reflected light from the direction of arrow A, both metallic and optically variable indicia are observed but, when viewed under reflected light from the direction of arrow B, all of the indicia appear metallic.

FIGS. 15a to 15d show an example of a design where the optically variable resist 20 and clear resist 21 are not printed in register. The optically variable resist 20 is printed as an array of stars (FIG. 15a) and the clear resist 21 is printed as a line pattern (FIG. 15b). FIGS. 15c and 15d shows the finished security device 19, viewed in reflected light from the direction of arrow A and arrow B respectively, with the indicia generated from the optically variable resist 20 and the clear resist 21. When viewing the device 19 from the side of arrow A the stars have an optically variable effect, for example changing colour from gold to green on changing the angle of view away from normal incidence. The lines have a reflective metallic appearance. On viewing the device 19 from the opposite side both the stars and the lines have a metallic appearance.

FIGS. 16a and 16d show a similar set of images to FIGS. 15a to 15d but where the optically variable resist 20 and the clear resist 20 are printed in register. In this case the optically variable regions of the low resolution image 13 regions and the metallic regions of the high resolution images 13 make up a single design or indicia rather than independent designs or indicia.

FIG. 17 shows a further embodiment of the invention in which, in some areas, the clear resist 21 overlaps the optically variable resist 20. The presence of the clear resist over the optically variable resist modifies the appearance of the optically variable indicia in the overlapping region as shown in FIG. 18.

FIGS. 19a to 19d illustrate the steps in another method of forming the security feature of the present invention in which the clear resist 21 is replaced with a second optically variable resist 23 which has different optical effect to that of the first optically variable resist 20, for example a different angular dependent colourshift. In this example the first optically variable resist 20 exhibits a red to green colourshift on changing the angle of view away from normal incidence and the second optically variable resist 23 exhibits a green to blue colourshift. Referring to FIGS. 15a to 15d the first optically variable resist 20 is applied as the array of stars and the second optically variable resist 23 is applied as the line pattern. When viewing the security feature 10 from the top side the stars exhibit a red to green colourshift and the lines exhibit a green to blue colourshift. On viewing the security feature 10 from the opposite side, both the stars and the lines have a metallic appearance.

In yet a further embodiment of the invention the two different optically variable resists 20,23 can overlap. This would be similar to the structure and design shown in FIG. 18 except that the clear resist 21 is replaced with a second different optically variable resist 23. In the overlapping regions 22 a third colour is observed due to the mixing of the two colours exhibited by the two optically variable resists at any given angle of view.

A number of other variations can also be made to the present invention. An optically variable resist can be used with optically variable print. This embodiment is similar to FIGS. 11a to 11c but with a further optically variable ink applied after the demetallisation process. In those regions where the second optically variable ink is applied over a demetallised area, it is visible from both sides of the device.

In each of the forgoing examples the images 12,13 may be applied in register or out of register.

The clear resist 21 in FIGS. 15a to 15d may also be replaced with a non-optically variable coloured resist. Preferably the colour of the non-optically variable resist matches one of the switching colours of the optically variable resist 20. For example if the optically variable resist 20 switches from red to green on tilting the security feature 10 away from normal incidence and the non-optically variable resist is coloured red, then on viewing at normal incidence the top side of the feature 10 will appear a uniform red colour. On tilting away from normal incidence the optically variable resist 20 will switch from red to green and the non-optically variable resist will remain red. In this manner a latent image security feature 10 can be created.

In a further embodiment the security device 19 may be transferred to a security substrate 16 in the form of a stripe or patch. FIG. 20 illustrates an example of a security device 19 suitable for application as a stripe or patch. The first and second images 12,13 are formed on a releasable polymeric carrier substrate 11 using the previously mentioned resist and etch method where the resist comprises an optically variable pigment and is used to form the low resolution second image 13. The device 19 can be applied to the security substrate 16 using an adhesive layer 15. The adhesive layer 15 is applied to either the security device 19, or the surface of the security substrate 16 to which the security device 19 is to be applied. After transfer, the carrier substrate 11 may be removed, leaving the security feature 10 as the exposed layer as illustrated in FIG. 21.

In order to visualise the optically variable effect of the second image 13 in reflection the device 19 must be applied over a substantially transparent area 17 of the security substrate 16. The example in FIG. 22 shows the security device 19 applied over a transparent region 17 in a polymeric banknote 25. The polymeric banknote 25 is formed from a transparent substrate 26 comprising at least one layer of an opacifying coating 27 on both sides of the substrate 26. The opacifying coating 27 is omitted in localised regions on both sides of the substrate 26 to form a transparent region 17. The security device 19 is then applied over the transparent region 17 such that when the security feature 10 in the polymeric banknote 25 is viewed from the direction of arrow A metallic indicia are observed but, when viewed under reflected light from the direction of arrow B optically variable indicia are observed.

Alternatively the security feature 10 of the present invention could be incorporated in a polymeric banknote 25 such that it is only visible from one side of the substrate 26. In this case the security feature 10 is applied to the transparent polymeric substrate 26 and on one side of the substrate 26 the opacifying coating 27 is omitted. This enables the side of the security feature 10 from which the optically variable indicia are visible to be viewed, while on the other side of the substrate 26 the opacifying coating 27 is applied over the security feature 10 such that it conceals the metallic indicia in reflection. On viewing in transmitted light, a sharp silhouette of the indicia will be observed due to the presence of the underlying metal high resolution image 12.

In a further embodiment the transparent substrate 26 of the polymeric banknote 27 provides the supporting substrate for the security feature 10.

Polymeric banknotes are just one example of a secure document based on a polymeric substrate. The present invention is equally applicable to other types of polymeric security documents.

1. A security feature, said feature comprising:
an opaque first image and a second image at least partially overlying the first image, the second image being a printed image which has a lower visual resolution than the first image and the formation of the second image is such that, when the security feature is viewed in transmitted and/or reflected light, only the shape of the first image is readily discernable.

2. The security feature as claimed in claim 1 in which a contrast ratio of the second lower resolution image to the first higher resolution image is less than 0.2 of the contrast ratio of the overall image relative to a background to which the security feature is applied.

3. The security feature as claimed in claim 1 in which the second image is printed with an ink comprising pigments having a large particle size.

4. The security feature as claimed in claim 3 in which the diameters of the pigment particles are of at least 10 μm.

5. The security feature as claimed in claim 3 in which the diameters of the pigment particles are at least 20 microns

6. The security feature as claimed in claim 3 in which the diameters of the pigment particles are at least 30 microns.

7. The security feature as claimed in claim 1 in which the second image is printed with an ink comprising pigments having a low packing density.

8. The security feature as claimed in claim 7 in which the pigment level in the ink with which the second image is printed is at least 10% by weight.

9. The security feature as claimed in claim 7 in which the pigment level in the ink with which the second image is printed is at least 20% by weight.

10. The security feature as claimed in claim 1 wherein the second image is printed with an ink containing optically variable particles which provide an optically variable effect where the second image overlies the first image when viewed in reflected light.

11. The security feature as claimed in claim 10 in which the optically variable particles are selected from the group consisting of: cholosteric liquid crystal pigments, pearlescent pigments, thin film interference pigments and holographic flakes.

12. The security feature as claimed in claim 1 in which the second image is printed with an ink which has a tactile effect.

13. The security feature as claimed in claim 1 in which the first image is a printed image.

14. The security feature as claimed in claim 1 in which the first image is formed from metal.

15. The security feature as claimed in claim 14 in which the ink with which the second image is printed is a resist comprising optically variable pigments which is used in a subsequent process to form the first image.

16. The security feature as claimed in claim 15 in which a second resist comprising optically variable pigments overlies the first image.

17. The security feature as claimed in claim 15 in which a clear resist overlies portions of the first and second images.

18. The security feature as claimed in claim 1 in which the first and second images are registered with respect to each other.

19. The security feature as claimed in claim 1 in which the first and second images are not registered to each other.

20. The security feature as claimed in claim 1 in which profiles of the first and second images are substantially the same as each other.

21. The security feature as claimed in claim 1 in which the perimeter of the second image does not extend beyond a perimeter of the first image.

22. The security feature as claimed in claim 21 in which a perimeter of the second image is indented with respect to a perimeter of the first image.

23. The security feature as claimed in claim 22 in which the perimeter of the second image is indented with respect to the perimeter of the first image by a margin lying in the range of approximately 10 to 100 microns.

24. A security device comprising a substantially transparent carrier substrate on which is formed the security feature of claim 1.

25. A security substrate comprising a substrate and a security device as claimed in claim 24.

26. The security substrate as claimed in claim 25 in which the security device is at least partially embedded within the substrate.

27. The security substrate as claimed in claim 25 in which the security feature is visible in a substantially transparent region of the security substrate which is otherwise opaque.

28. The security substrate as claimed in claim 25 in which the security device is applied to a surface of the substrate.

29. The security substrate comprising a substrate to which the security feature of any one of claims 1 to 23 is applied.

30. A security document formed from a security substrate as claimed in claim 25.

31. The security document as claimed in claim 30 selected from the group consisting of: voucher, fiscal stamp, authentication label, passport, cheque, certificate, identity card, and banknote.

32. A method of forming a security feature, said method comprising the followings steps:
forming on a substrate a first opaque image and a printed second image at least partially overlying the first image, the second image being a printed image which has a lower visual resolution than the first image and the formation of the second image is such that, when the security feature is viewed in transmitted and/or reflected light, only the shape of the first image is readily discernable.

33. The method as claimed in claim 32 in which the first image is printed.

34. The method as claimed in claim 33 in which the first and second images are printed by means of a registered printing process.

35. The method as claimed in claim 32 in which the first and/or second images are printed by means of a screen printing process.

36. The method as claimed in claim 32 in which the first and/or second images are printed by means of a gravure process.

37. The method as claimed in claim 32 in which the first image is provided by applying metal regions to form the image to the substrate.

38. The method as claimed in claim 32 in which the first image is formed by partially demetallizing a layer of metal on the substrate to leave metal regions.

39. The method as claimed in claim 37 in which a resist is printed on the metal layer before demetallization, which resist provides the second image.

40. (canceled)

41. (canceled)

42. (canceled)
